(19) United States
(12) Patent Application Publication
(10) Pub. No.: US 2010/0138294 A1
(43) Pub. Date: Jun. 3, 2010

(54) PROVISION OF LOCATION-BASED ADVERTISING

(75) Inventors: Alexander T. Bussmann, Toronto (CA); Joseph Figueroa, Kirkland, WA (US); Todd Segal, Seattle, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/327,724

(22) Filed: Dec. 3, 2008

(51) Int. Cl. G06Q 30/00; G06Q 40/00; G06Q 90/00

(52) U.S. Cl. 705/14.49; 705/37

(57) ABSTRACT

The provision of location-based advertising services is disclosed. One disclosed embodiment provides a method of operating a location-based advertising server. The method comprises receiving from each of a plurality of advertising publishers an item of advertising content associated with a bounded area defined in a geographic region, and also receiving from each advertising publisher a bid for payment for distributing the advertising publisher's item of advertising content to devices. The method then comprises receiving from a device a request for advertising content associated with the bounded area, and sending an item of advertising content associated with a highest bid to the device.

### BACKGROUND

Location-based services are services available to various devices, including but not limited to personal navigation devices (PND), via a mobile network that make use of a geographic location of a device accessing the network to provide location-specific information. Examples of location-based services may include, but are not limited to, identifying businesses near a user, helping drivers or pedestrians navigate to a desired destination, providing personalized weather reports, and providing traffic alerts related to nearby traffic problems.

Various mechanisms may be used to determine a location of a user. Examples of locating mechanisms include, but are not limited to, global positioning systems (GPS) and multilateration methods. Such locating capabilities may be included in a variety of devices, including but not limited to GPS devices, cell phones, smart phones, laptop computers, desktop computers, etc. As the number of devices equipped with such locating capabilities continues to rise, the market for location-based services may continue to rise correspondingly.

### SUMMARY

Various embodiments are disclosed herein that relate to the provision of location-based advertising services. For example, one disclosed embodiment provides a method of operating a location-based advertising server. The method comprises receiving from each of a plurality of advertising publishers an item of advertising content associated with a bounded area defined in a geographic region, and also receiving a bid for payment for distributing the advertising publisher's advertising content to devices. The method then comprises receiving from a device a request for advertising content associated with the bounded area, and sending an item of advertising content associated with a highest bid to the device.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows an embodiment of a method of operating a location-based advertising server.

FIG. 2 shows a block diagram of an embodiment of a location-based advertising use environment according to the present disclosure.

FIG. 3 shows an embodiment of a map of a geographic region divided into a plurality of bounded areas.

FIG. 4 shows an embodiment of method of interacting with a location-based advertising server.

FIG. 5 shows another embodiment of a method of operating a location-based advertising server.

### DETAILED DESCRIPTION

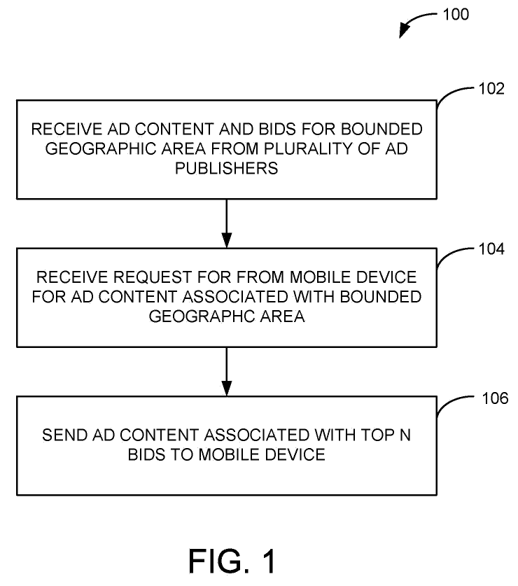

FIG. 1 shows a flow diagram depicting an embodiment of a method 100 of providing location-based advertising services. Method 100 comprises, at 102, receiving advertising content and pricing bids from each of a plurality of advertising publishers. As explained in more detail below, the pricing bids comprise an offer to pay a specified amount of money in exchange for having the advertising content of the bidder sent to a device for presentation to a user. Further, the advertising content and bid are associated with a specific bounded geographic area defined in a geographic region. Therefore, the advertising content is sent to devices located within, or within some distance adjacent to, the bounded area. Next, method 100 comprises, at 104, receiving a request from a device for advertising content associated with the bounded area. Then, method 100 comprises, at 106, sending advertising content associated with the top N bids to the device for presentation to a user of the device, wherein N may be zero (in the case of no bids) or a positive integer. In this manner, advertising publishers may bid a specific price to pay for the distribution of advertising content in a specified geographic area, and the highest bidder or bidders win priority to have advertising content items presented to a device user over other lower bidders.

Depending upon various device-specific parameters of the device and the nature of the advertising content sent to the device, one or more items of advertising content may be presented on the device at any one time. Therefore, in some circumstances, the highest bidder's advertising content alone may be sent to a requesting device, while in other circumstances, more than one item of advertising content may be sent to a requesting device. Where more than one item of advertising content is sent to a device, the items of advertising content may be selected based upon descending order of bids. As a specific example, a GPS-enabled smart phone may allow a map to be displayed at various levels of zoom. In one example, for a specific level of zoom in a specific geographic region, the smart phone may be able to display three items of advertising content on a map. In this case, the device may be sent items of advertising content for the top three bidders for the geographic area displayed on the map. Therefore, advertising publishers who wish to have advertising content sent to mobile phones have an incentive to bid close to or above a highest bid for a desired bounded geographic area. This may help to obtain higher bids for distributing the advertising content items, and therefore may contribute to greater economic returns per advertisement view. More detailed implementations of method 100 are discussed in more detail below.

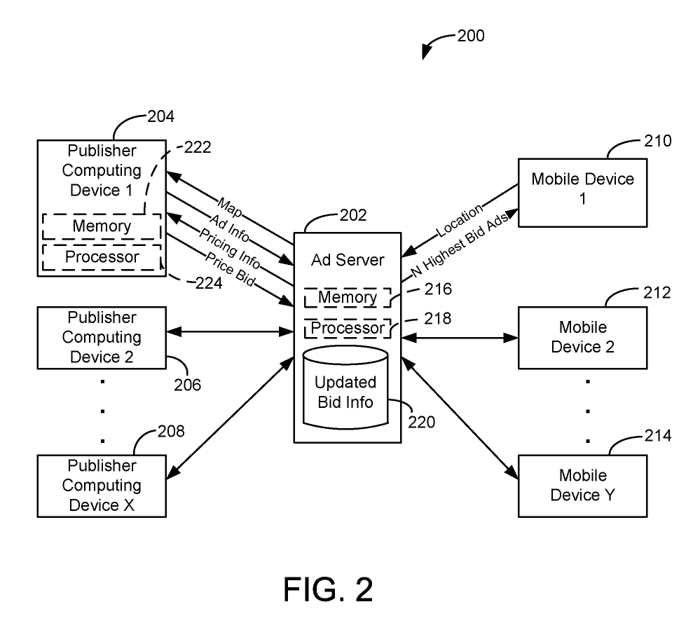

FIG. 2 shows an example embodiment of a location-based advertising use environment 200. Use environment 200 comprises an advertising server 202 in communication with a plurality of advertising publisher computing devices 204, 206, 208, and also with a plurality of devices 210, 212, 214 that request and receive advertising content from the advertising server 202. In the depicted embodiment, the number of advertising publisher client computing devices in communication with the advertising server 202 is illustrated as a generic number X, and the number of requesting/receiving devices is illustrated as a generic number Y, indicating that any suitable number of advertising publisher client computing devices and requesting/receiving devices may be in communication with the advertising server 202 at any time.

The advertising server 202 comprises memory 216 and a processor 218, wherein the memory 216 comprises instructions stored thereon that are executable by the processor 218 to perform the various methods of operating an advertising server disclosed herein. The advertising server 202 further comprises a database 220 that stores various items of information related to the provision of location-based advertising services. For example, the database 220 may store user account information related to the advertising publishers and/or consumer devices that utilize the system. The database 220 also may store advertising content provided by each advertising publisher, and bid information related to the advertising content. The term “updated bid information” may be used herein to describe such current bid information, as bids may be submitted and/or modified by advertising publishers on a continuous, rolling basis. The updated bid information may include such information as the geographic locations and time intervals selected by each advertising publisher for the distribution of advertising content, category information related to the type of advertising content provided by each advertising publisher and to the specific distribution services requested by the advertising publisher, pricing information related to the price paid by each advertising publisher for a desired transaction type (per view, per click-through, etc.), payment information related to the method of payment used by each advertising publisher (pre-paid credits, debit/credit card info, etc.), or any other suitable information.

Each publisher computing device 204, 206, 208 also comprises memory having stored instructions executable by a processor for performing the various client-side methods disclosed herein. The memory and processor are shown at 222 and 224, respectively, for advertiser publisher computing device 204, but are omitted for computing devices 204 and 206 for clarity.

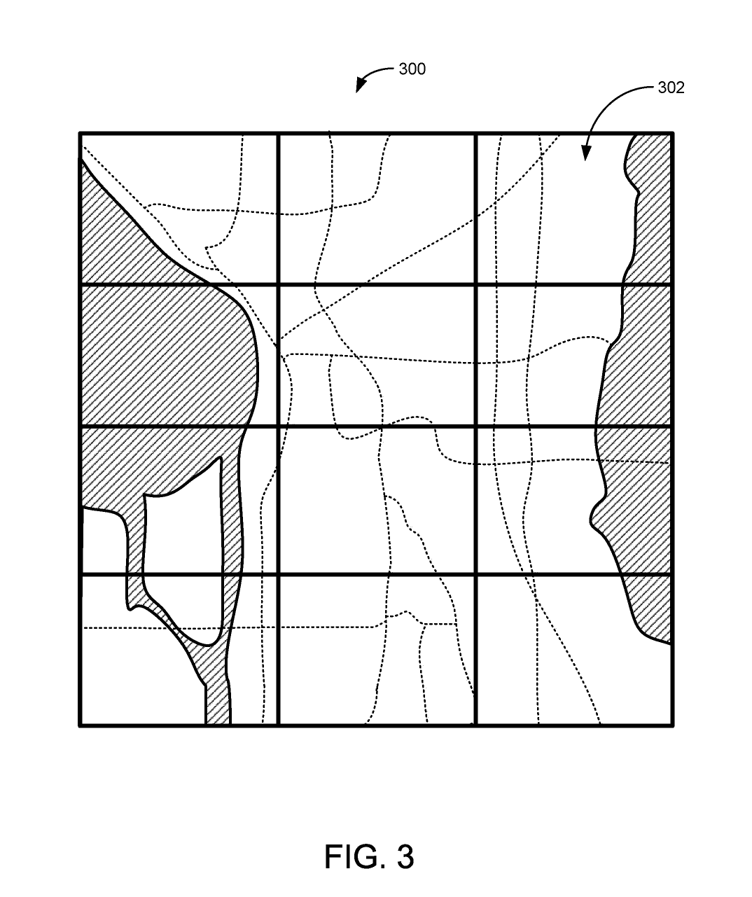

As described above, the bids submitted by each advertising publisher related to a specific bounded area or areas in a geographic region of interest. To enable the solicitation and receipt of such bids, the advertising server 202 may be configured to send each advertising publisher computing device 204, 206, 208 a map showing a geographic region of interest divided into one or more bounded areas. Such bounded areas may be referred to herein as “tiles” defined on the map, and a map that is divided into such bounded areas may be referred to as a “tiled map.” FIG. 3 is an example of map 300 showing a geographic region divided into a plurality of tiles 302. The number and size of tiles into which a geographic region is divided may be selected in any suitable manner. For example, dense urban areas with many businesses per map unit area may be divided into smaller tiles, while less dense rural areas may be divided into larger tiles. In this manner, each individual tile may be separately priced depending upon demand for the distribution of location-based advertising content items in that tile. Likewise, the tiles may have any suitable shape. In the depicted embodiment, the tiles are rectangular in shape and are of equal size. However, in other embodiments, the tiles may have any other suitable shape, and may be of unequal size. Furthermore, while the depicted map is shown as a two-dimensional representation of a geographic area, it will be understood that the map may support either fewer or more dimensions. For example, some maps may be tiled along a third physical dimension. An example of such a scenario is a city with high-rise buildings, wherein different advertising content items may be displayed at different elevations within buildings in the area.

In some embodiments, each tile may have an appearance characteristic that indicates a current pricing for the tile. For example, the tiles may be depicted in colors configured to indicate an approximate current price for each tile. As a more specific example of such an embodiment, tiles with below-average current prices may be shown or shaded in green, tiles with approximately average current prices in yellow, and tiles with above-average current prices in red. Further, in some embodiments, a current price of each tile (i.e. the price of a highest bidder), or a current price paid by each of a plurality of highest bidders, may be displayed on or in connection with each tile. It will be understood that these specific examples are described for the purpose of example, and are not intended to be limiting in any manner.

Upon receipt of such a map, an advertising publisher computing device 204 may receive an input of a selection of one or more tiles in which the publisher wishes to have its advertising content distributed, and then send the selection to the advertising server along with the item or items of advertising content the publisher wishes to distribute. The advertising publisher computing device 204 also may send other advertising information, such as advertising category information and desired advertising times, to the advertising server 202. This information is collectively referred to as “ad info” in FIG. 2. Upon receipt of this information, the advertising server 202 may provide pricing information to the advertising publisher computing device 204. In some embodiments, the pricing information may comprise a “future price”, as opposed to the current price reflected by the map, and may be determined by a highest existing bid or bids for each selected tile over the requested time interval in light of the category information provided by the advertising publisher. In some embodiments, the total price for a multi-tile area may be lower than a sum of the highest bids for each requested tile for the requested time interval, while in other embodiments, the price for a multi-tile area may have any other suitable relationship to the sum of the individual tile pricings. As described below, the pricing information may be continuously updated as bids are received from various users and demand for the tiles increases or decreases. Further, where no bids have been made on a selected tile, the pricing information may comprise a preselected minimum price for a tile.

Any suitable category information sent by the advertising publisher computing devices 204, 206, 208 to the advertising server 202. For example, such category information may comprise a type of advertising content the publisher wishes to distribute. Examples of such advertising content items include, but are not limited to, sound-based ads, image-based ads, text-based ads, interactive ads, static ads, etc. More advanced category information also may be supported. Examples of more advanced advertising category information that may be sent by an advertising publisher include, but are not limited to, information regarding a size of the advertising content on the display, and/or a presence or absence of sound to accompany an image-based or text-based advertising content item. A more specific example comprises a choice between a large icon and a small icon displayed on a map. Another more specific example comprises a choice of displaying a map icon with or without sound.

In other embodiments, the category information may comprise a type of device on which an advertising publisher wishes to display advertising content, and/or a zoom level on a device at which the advertising publisher wishes for an item of advertising content to be triggered. For example, an advertising publisher may wish to display one item of advertising content on smaller devices, such as cell phones, and another item of advertising content on larger devices, such as laptop computers. Therefore, in some embodiments, the advertising publisher may have the ability to specify a type of device, brand/model of device, etc. on which specific advertising content is to be presented.

In yet other embodiments, the category information may include a selection of whether to request exclusive or non-exclusive advertising rights in one or more selected tiles. Such “exclusive” rights may include the right to exclude other advertising content items from being displayed in connection with the exclusive tile for a designated period of exclusivity, or to exclude advertising content items from other advertisers offering a same or similar type of goods or services for the period of exclusivity. In the latter example, advertising publishers may provide, as additional category information, a type of goods or services being advertised. In either example, the tile or tiles subject to the exclusive rights may be blacked out on the tiled map for the duration of the exclusive rights. Other forms of exclusive rights may include, but are not limited to, any suitable type of higher-value rights or premium service, such as the display of a larger icon relative to other advertisers, etc.

Upon receipt of the pricing information, the publisher computing device 204 may then receive an input of a price bid or bids from a user of the publisher computing device 204 specifying a price the advertising publisher is willing to pay for one or more types of advertising transaction. The publisher computing device 204 may then send the price bid or bids to the advertising server 202. In some embodiments, a single bid may be provided for all supported types of advertising transactions, while in other embodiments separate bids may be received for one or more types of advertising transactions. Examples of types of advertising transactions include, but are not limited to, views of an item of advertising content, click-throughs to view detailed advertisement information, navigations from an item of advertising content to a web page for the advertising entity, etc.

Upon receipt of the price bid, the advertising server 202 stores the bid in the updated bid information database 220. In this manner, the advertising server 202 may price location-based advertising services using a continuous rolling auction-like process in which N-dimensional virtual space on a map is bid on by multiple advertising publishers. Further, in some embodiments, advertising publishing computing devices may send updates to previously submitted bids stored in the updated bid info database 220, for example, to increase or reduce a price bid in response to the bidding actions of other advertising publishers.

Continuing with FIG. 2, the advertising server 202 is also configured to provide advertising content to devices 210, 212, 214 that request content for specified locations. When requesting advertising content, a device (such as device 210) sends information regarding its geographic location to the advertising server 202. The device 210 also may send other information. For example, the device 210 may send information regarding its type, manufacturer and/or model identity. Such information may allow the advertising server 202 to select items of advertising content intended for that type of device. The device 210 also may send information regarding a current zoom level at which the display on the device is currently being viewed. Such information may allow the advertising server to select items of advertising content configured to trigger at the specified level of zoom, and/or to determine how many items of advertising content can be viewed at one time on the device display and therefore to select how many advertising content items to send to the device.

After determining how many items of advertising content to send to the device, the advertising server 202 may be configured to identify the items of advertising content associated with the N highest bids, wherein N is the number of items of advertising content to send to the device. It will be understood that N may be any positive integer, or may be zero where no bids exist for a selected tile during a selected time interval. Then, the advertising server 202 may send the identified items of advertising content to the device.

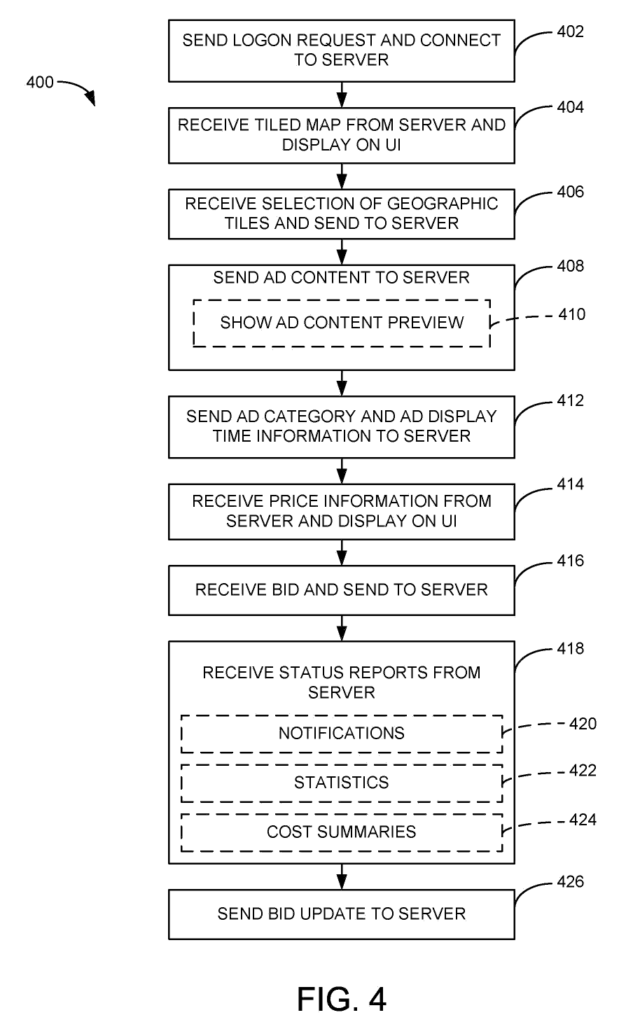

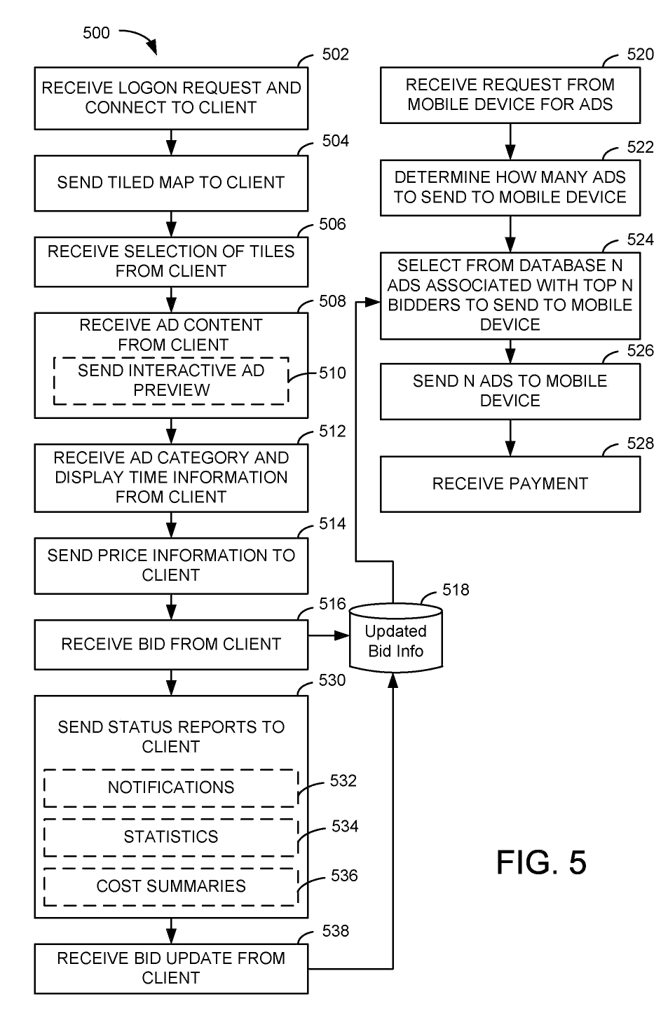

FIGS. 4 and 5 show embodiments of more detailed implementations of the various concepts discussed above. First, FIG. 4 shows an embodiment of a method 400 of interacting with an advertising server, from the standpoint of an advertising publisher client. Method 400 first comprises, at 402, sending a logon request to the advertising server and connecting to the server. This assumes that the party logging onto the advertising server has already set up an account on the advertising server. Further, this step may include the process of setting up an account on the advertising server where the party connecting to the server is a new user.

Next, method 400 comprises, at 404, receiving a tiled map from the server and displaying the tiled map on a graphical user interface, wherein the tiled map shows an N-dimensional view of a geographic region divided into one or more tiles. In this manner, an advertising publisher may select tiles corresponding to geographic areas in which (or in connection with which) the publisher wishes to have an item of advertising content displayed. As described above, each tile may have any suitable shape and size. For example, dense urban areas may be divided into more tiles than less dense rural areas. Further, each tile may have a size and shape similar to the other tiles, or one or more tiles may have different sizes and shapes compared to the other tiles. In some embodiments, the tiles may have arbitrary polygonal (or polycurved, etc.) shapes that do not correspond to geographic features of the region represented by the map. In other embodiments, the tiles may have boundaries that follow geographic features of the region represented by the map. Further, the map may be displayed in colors or other visual indicators of the relative demand and/or cost of each tile displayed.

Method 400 next comprises, at 406, receiving a selection of tiles from a user via the graphical user interface, and then sending the selection of tiles to the advertising server. In addition to the selection of tiles, advertising content for the selection of tiles also may be sent to the advertising server, as indicated at 408. In some embodiments, as indicated at 410, the advertising content may then be viewed in a preview feature offered by the advertising content server. Such a preview may allow an advertising publisher to view a representation of how advertising content may appear to users of different types of devices, at different levels of zoom and/or panning, etc. In this manner, an advertising publisher may use the preview process as an aid to developing effective advertising content for specific devices, locations, etc.

Continuing with FIG. 4, method 400 next comprises, at 412, sending category information and display time information to the advertising server. As described above, the advertising category information may comprise information related to a type of item of advertising content to be displayed, any exclusive advertising rights that are requested, and/or any other suitable information. Likewise, the display time information may comprise information related to time periods during which the advertising publisher wishes for its advertising content to be distributed to devices in the selected tiles. It will be understood that such information may be sent to the server at the same time the selection of tiles is sent to the server, or may be sent to the server either before or after the selection of tiles is sent to the server.

After sending the selection of tiles and other information described above, method 400 next comprises, at 414, receiving pricing information from the advertising server and displaying the pricing information on a user interface. The pricing information may indicate, for example, a price the advertising publisher will be charged for one or more advertising transactions involving the submitted item or items of advertising content. Examples of advertising transactions for which pricing information may be displayed include, but are not limited to, price per navigation, price per click-through, price per view, etc. In some embodiments, this pricing information may be displayed on a tile-by-tile basis, while in other embodiments, a single price that is determined based upon the individual pricings of each selected tile over the desired time interval may be displayed.

The prices displayed for each tile may be determined in any suitable manner. For example, where previous bids have been made for a tile at the selected time interval, the price displayed may be a sum of the highest bid or bids for the selected tiles over the selected time interval, or may be lower or higher than this sum. Where no previous bids have been made, the price displayed may be a pre-determined minimum price per unit time.

After receiving and displaying the pricing information, method 400 next comprises, at 418, receiving a bid via the user interface and then sending the bid to the advertising server. The bid comprises one or more offers of prices that the advertising publisher submitting the bid is willing to pay for one or more advertising transactions in the selected tiles during the selected time interval. The bid may or may not be at or over the prices given in the pricing information received from the advertising server. However, where the bid is lower than the highest bids, it may be less likely that the advertising publisher's advertising content will be distributed, as the lower bid gives the associated item of advertising content a lower priority. Therefore, an advertising publisher who wishes to ensure that its advertising content is distributed may have an incentive to submit a bid higher than the prices given in the pricing information received from the advertising server. It will be understood that payment arrangements may also be made during the bid submission process, or at any other suitable time. Payment for advertising transactions may be made in any suitable manner. Examples include, but are not limited to, pre-paid credits, debit or credit cards, lines of credit, etc.

Once the bid has been submitted for an item of advertising content, the advertising content and bid information (including price bid, category information, time information, etc.) may be stored in an updated bid database that is continuously updated as new bid information is received, and that is continuously accessible to provide advertising content to requesting devices.

In light of the dynamic and potentially changing pricing environment, an advertising publisher who submits a bid and advertising content may wish to be notified upon the occurrence of various advertising transactions, and/or to periodically receive statistical information regarding advertising transactions involving the publisher's advertising content, cost information, etc. Therefore, method 400 may comprise, at 418, receiving one or more status reports from the advertising server. The status reports may be received a single time during the requested time interval (e.g. at the end of the requested time interval), periodically during the requested time interval, or on any other suitable temporal basis. Likewise, the status reports may comprise any suitable information. As shown in FIG. 4, such status reports may comprise notifications 420 (for example, of the receipt of a higher bid, of the occurrence of specified advertising transactions, etc.), statistics 422 (for example, regarding frequency or number of advertising transactions involving publisher's advertising content compared to other publishers' advertising content, etc.), and/or cost summaries 424 (for example, regarding itemized and/or total fees paid for occurrences of advertising transactions). It will be understood that these types of information that may be included in status reports are described for the purpose of example, and are not intended to be limiting in any manner.

Under some circumstances, an advertising publisher may wish to update a previously-submitted bid. For example, an advertising publisher may wish to increase a bid where other users have submitted higher bids. Likewise, an advertising publisher may wish to temporarily decrease or withdraw a bid in order to save money by decreasing a likelihood of future advertising transactions involving that publisher's advertising content. Therefore, method 400 comprises, at 426, sending an updated bid to the server, wherein the updated bid changes one or more items in the original bid. The updated bid may comprise a higher or lower price bid, new or updated category information, a change in the originally requested time interval, or any other suitable updated information. In this manner, an advertising publisher may be able to quickly and easily adjust the distribution of its advertising content, and therefore its advertising costs, in real-time and on an as-desired basis.

Continuing with the figures, FIG. 5 shows a method 500 of operating an advertising server. Method 500 illustrates various details of method 400 from the advertising server's point of view, where communications with an advertising publisher client are shown in a left-hand side of the figure and communications with a device are shown in a right-hand side of the figure. Method 500 first comprises, at 502, receiving a logon request from an advertising publisher client, and connecting to the client. Next, at 504, a tiled map is sent to the client to allow the advertising publisher to select tiles in which it is interested in having its advertising content distributed.

After sending the tiled map, a selection of tiles on the map is received from the client at 506, and advertising content is received from the client at 508. As described above, in some embodiments, an advertising server may be configured to allow an advertising publisher to view a preview of advertising content in the tiles selected by the advertising publisher. Therefore, method 500 comprises, at 510, sending an advertising content preview to the client. In some embodiments, the advertising content preview may be an interactive preview configured to allow an advertising publisher to view an item of advertising content on different types of devices, at different levels of zoom, panning, etc. to see how the item of advertising content will appear to a user in various specific geographic locations. In this manner, an advertising publisher may be able to tailor an appearance of an item of advertising content to a desired appearance in a specific device and/or location.

Method 500 next comprises, at 512, receiving advertising category and advertising display time information from the client. Examples of category and display time information are discussed in detail above. While the depicted embodiment shows the category and time information appearing in a later step than the receipt of the ad content and selection of tiles, it will be understood that these items may be received in any suitable order.

Upon receipt of the selection of tiles, ad content, and category and time information, method 500 comprises, at 514, sending price information to the client, and then at 516, receiving a bid from a client. The bid is then stored in an updated bid information database, as indicated at 518. It will be understood that processes 502-518 may be performed by a plurality of different publishers on a continuous, rolling basis as clients wish to submit bid information. Further, the advertising server also may interact with requesting devices on a continuous, rolling basis to provide items of advertising content to the devices. An example of a transaction with a device such as a PND or the like is shown in FIG. 5 at 520-526. First, at 520, method 500 comprises receiving from a device a request for advertising content. Upon receipt of this request, it is determined, at 522, a number N of items of advertising content to send to the device. The number N of items of advertising content may vary depending upon a number of factors, including but not limited to, a type/brand/model of device that sent the request, a current level of zoom currently shown on the device display, and/or whether any advertising publishers have paid for exclusive advertising rights to a tile that is within the relevant geographic area.

After determining the number N advertising content items to send to the device, items of advertising content associated with the N highest bidders are selected from the updated bid information database at 524, and then sent to the device at 526 for presentation to a user of the device. Further, payment is received, at 528, from the advertising publishers that submitted the N highest bids.

Information about an advertising transaction or transactions that occur after sending the N advertising content items may be stored in the updated bid information database (or in any other suitable location). This may be used in preparing status reports to be sent to the advertising publisher client, as indicated at 530. As described above, such status reports may be sent in response to any suitable trigger (e.g. passage of a time interval, occurrence of an advertising transaction, receipt of a request for a report from a client, etc.), and may contain any suitable information. As described above, such status reports may comprise notifications 532, statistics 534, and/or cost summaries 536 (for example, regarding total fees paid for occurrences of advertising transactions. It will be understood that these types of information that may be included in status reports are described for the purpose of example, and are not intended to be limiting in any manner.

As described above, under some circumstances an advertising publisher may wish to update a previously-submitted bid, for example to increase or decrease a price of a bid in response to changing conditions. Therefore, method 500 comprises, at 538, receiving an updated bid that changes one or more items in the original bid. The updated bid may comprise a higher or lower price bid, new or updated category information, a change in the originally requested time interval, or any other suitable update. In this manner, an advertising publisher may be able to quickly and easily adjust the distribution of its advertising content, and therefore its advertising costs, in real-time and on an as-desired basis.

It will be understood that the term “computing device” as used herein may refer to any suitable type of computing device configured to execute programs. Such computing device may include, but are not limited to, a mainframe computer, personal computer, laptop computer, portable data assistant (PDA), computer-enabled wireless telephone, networked computing device, combinations of two or more thereof, etc. Likewise, the term “requesting/receiving device” and the like (e.g. where the abbreviated term “device” is used to refer to such a device) also may refer to any suitable type of computing device that can access a network and receive advertising content. As used herein, the term “program” refers to software or firmware components that may be executed by, or utilized by, one or more computing devices described herein, and is meant to encompass individual or groups of executable files, data files, libraries, drivers, scripts, database records, etc. It will be appreciated that a computer-readable storage medium may be provided having program instructions stored thereon, which upon execution by a computing device, cause the computing device to execute the methods described above and cause operation of the systems described above.

While the provision of location-based advertising services is described herein in the context of specific example embodiments, it will be appreciated that the configurations and/or approaches described herein are exemplary in nature, and that these specific embodiments or examples are not to be considered in a limiting sense, because numerous variations are possible. The specific routines or methods described herein may represent one or more of any number of processing strategies such as event-driven, interrupt-driven, multi-tasking, multi-threading, and the like. As such, various acts illustrated may be performed in the sequence illustrated, in parallel, or in some cases omitted. Likewise, the order of any of the above-described processes is not necessarily required to achieve the features and/or results of the embodiments described herein, but is provided for ease of illustration and description. The subject matter of the present disclosure includes all novel and nonobvious combinations and subcombinations of the various processes, systems and configurations, and other features, functions, acts, and/or properties disclosed herein, as well as any and all equivalents thereof.

1. A method of operating a location-based advertising server, comprising:
receiving from each advertising publisher of a plurality of advertising publishers an item of advertising content associated with a bounded area defined in a geographic region;
receiving from each advertising publisher a bid for payment for distributing the advertising publisher's item of advertising content to devices that request advertising content from the advertising server;
receiving from a device a request for advertising content associated with the bounded area; and
sending an item of advertising content associated with a highest bid to the device.

2. The method of claim 1, wherein sending advertising content associated with a highest bid comprises sending advertising content associated with a highest N number of bids, wherein N is a positive integer.

3. The method of claim 1, further comprising sending each advertising publisher pricing information for the bounded area before receiving the bid from the advertising publisher.

4. The method of claim 3 further comprising receiving advertising category information from the advertising publisher before sending the pricing information to the advertising publisher.

5. The method of claim 4, wherein the category information comprises one or more of a type of advertising content and a type of goods or services being advertised.

6. The method of claim 3, further comprising receiving time information specifying a time interval for the advertising publisher's advertising content to be distributed.

7. The method of claim 3, further comprising receiving a request for exclusive advertising rights within the bounded area, and wherein sending pricing information comprises sending pricing information for exclusive rights.

8. The method of claim 1, further comprising receiving an updated bid from one or more advertising publishers.

9. The method of claim 1, further comprising receiving a selection of a plurality of bounded areas within the geographic region.

10. The method of claim 1, further comprising sending each advertising publisher a map showing the bounded areas defined in the geographic region before receiving the bid from each advertising publisher.

11. The method of claim 1, further comprising determining a number of advertising content items to send to a device.

12. The method of claim 1, further comprising receiving a request to view an advertisement preview from a requesting advertising publisher, and providing the advertisement preview to the requesting advertising publisher.

13. A computing device, comprising:
a processor; and
memory comprising instructions stored thereon that are executable by the processor to perform a method of distributing advertising content, the method comprising:
sending to each advertising publisher of a plurality of advertising publishers a map showing a geographic region divided into a plurality of bounded areas;
receiving from each advertising publisher a selection of one or more selected bounded areas of the geographic region in which to distribute advertising content provided by the advertising publisher;
sending each advertising publisher current pricing information for the one or more selected bounded areas selected by that advertising publisher;
receiving from each advertising publisher a price bid for the one or more selected bounded areas selected by that advertising publisher;
receiving from a device a request for location-based advertising content associated with a bounded area of interest; and
sending to the device one or more items of advertising content associated with N highest bids for the bounded area of interest, wherein N is zero or a positive integer.

14. The computing device of claim 13, wherein the instructions are further executable to receive advertising category information from each advertising publisher before sending the pricing information to the advertising publisher.

15. The computing device of claim 14, wherein the category information comprises a type of advertising content.

16. The computing device of claim 13, wherein the instructions are further executable to receive a request for exclusive advertising rights within a selected bounded area, and wherein sending pricing information comprises sending pricing information for exclusive rights in the selected bounded area.

17. A computer-readable storage medium executable by a computing device to perform a method of distributing advertising content, the method comprising:
receiving a map from an advertising server, the map showing a geographic region divided into a plurality of bounded areas;
receiving from a user a selection of one or more bounded areas;
sending the selection of the one or more bounded areas to the advertising server;
sending advertising content associated with the one or more bounded areas to the server;
receiving pricing information from the advertising server; and
sending a price bid to the advertising server.

18. The method of claim 17, further comprising sending category information and time information to the advertising server.

19. The method of claim 17, further comprising sending a request for exclusive advertising rights to a selected bounded area to the server, and receiving pricing information for the exclusive advertising rights.

20. The method of claim 17, further comprising displaying an advertisement preview.
